(19) United States
(12) Patent Application Publication
(10) Pub. No.: US 2006/0008167 A1
(43) Pub. Date: Jan. 12, 2006

(54) Digital camera having picture quality setting

(76) Inventors: Qing Yu, Rochester, NY (US); Jiebo Luo, Rochester, NY (US); Rodney L. Miller, Fairport, NY (US)

Correspondence Address: Pamela R. Crocker;Patent Legal Staff, Eastman Kodak Company, 343 State Street, Rochester, NY, 14650-2201, US

(21) Appl. No.: 10/885,143

(22) Filed: Jul. 6, 2004

(51) Int. Cl. G06K 9/36

(52) U.S. Cl. 382/250

(57) ABSTRACT

A method of storing an image in a digital camera, comprising the steps of: capturing the image using the selected quantization table. A method of storing an image in a digital camera, wherein the step of selecting a quantization table comprises the steps of: selecting a quality setting; compressing the image using a quantization table corresponding to the selected quality setting; decompressing the image; evaluating the decompressed image with the image quality metric; and, adjusting the quantization table such that the quality metric matches the selected quality setting.

### FIELD OF THE INVENTION

The present invention relates to digital image capture, and more particularly to a digital camera having a picture quality setting.

### BACKGROUND OF THE INVENTION

Digital cameras such as the Kodak DC 280 apply JPEG compression prior to storing captured images in a camera memory card. JPEG compression involves performing a discrete cosine transform (DCT) on blocks of pixels (e.g. 8×8) of the image. The DCT coefficients are quantized to compress the image, and the quantized coefficients are entropy encoded (e.g. Huffman encoding) to produce the compressed image file. Such cameras may include a picture quality setting feature that allows the operator to select a quality option, for the image that is stored in the camera. The quality selection chooses a quantization table scale factor or quantization table used to quantize the DCT coefficients.

Generally a smaller image file results from a lower quality setting, and vice versa. One problem with this approach is that for a given quality setting images having different amounts of image detail will have different apparent quality. For example a very busy image compressed at an intermediate quality setting will have a low quality appearance, whereas an image with very little detail may have a high quality appearance even if it is compressed at the lowest quality setting.

There is a need therefore for an improved technique for accurately adjusting image quality in a digital camera.

### SUMMARY OF THE INVENTION

The need is met according to the present invention by providing a method of storing an image in a digital camera, comprising the steps of: capturing an image; selecting a quantization table based on an image quality metric; and compressing the image using the selected quantization table.

### BRIEF DESCRIPTION OF THE DRAWINGS

FIG. 1 shows a typical digital camera architecture.

FIG. 2 shows a block diagram of one embodiment of the current invention.

### DETAILED DESCRIPTION OF THE INVENTION

Memory cards (i.e., CompactFlash card) are widely used by digital capture devices such as digital cameras to store captured images before they are transferred to other storage mediums. Due to the limited capacity of a memory card, digital cameras such as the Kodak DC 280 apply JPEG compression prior to storing captured images in a camera memory card. JPEG compression involves performing a discrete cosine transform (DCT) on blocks of pixels (e.g. 8×8) of the image. Image compression is achieved when the DCT coefficients are quantized with a quantization table. The quantized coefficients are entropy encoded (e.g. Huffman encoding) to produce the compressed image file.

Different levels of compression can be achieved with different quantization tables, and in general, the more an image is compressed, the lower the quality the image has, and vice versa. Therefore, digital cameras such as the Kodak DC 280 normally include a picture quality setting feature that allows the operator to select a quality option, essentially trading off between image quality and the number of images that can be stored in a memory card. Within the camera design, the quality selection actually chooses an appropriate quantization table used to quantize the DCT coefficients.

The current invention adds intelligence to the quantization table selection process by adding an image analysis step using certain image quality metric(s). With this image-dependent approach, consistent apparent quality may be achieved for images having different amounts of details.

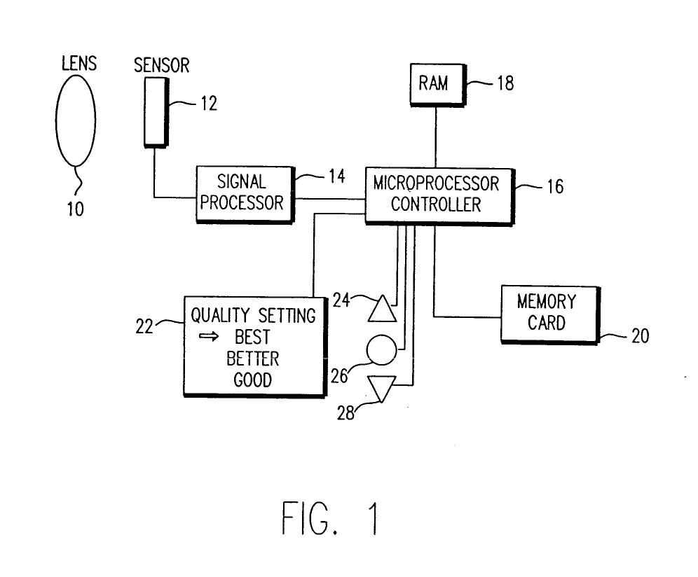

Referring first to FIG. 1, a typical digital camera architecture is shown. Lights from a scene pass through camera lens 10, and are collected by the sensor 12. The sensor image is then sent to a signal processor 14 where various image processing steps may take place (i.e., CFA interpolation, color correction). A typical digital camera also has other peripherals such as RAM 18 where intermediate images are stored, memory card 20 where the captured images are finally stored. All these peripherals are normally controlled by a microprocessor controller 16 acting as a coordinator.

For camera settings (i.e., quality, date) as well as for image preview, a LCD 22 is also included in a typical digital camera along with buttons 24 26 28 for navigating within the LCD. For example, underneath the Quality Setting, a camera may let users select from three choices (as shown in FIG. 1):

“Best”, “Better” and “Good”, respectively. A user may press up arrow button 24 or down arrow button 28 to switch among these three settings, and then press the selection button 26 for final quality selection. All these actions are coordinated by the microprocessor controller, and the quality selection by a user will eventually be feedback to the microprocessor as well.

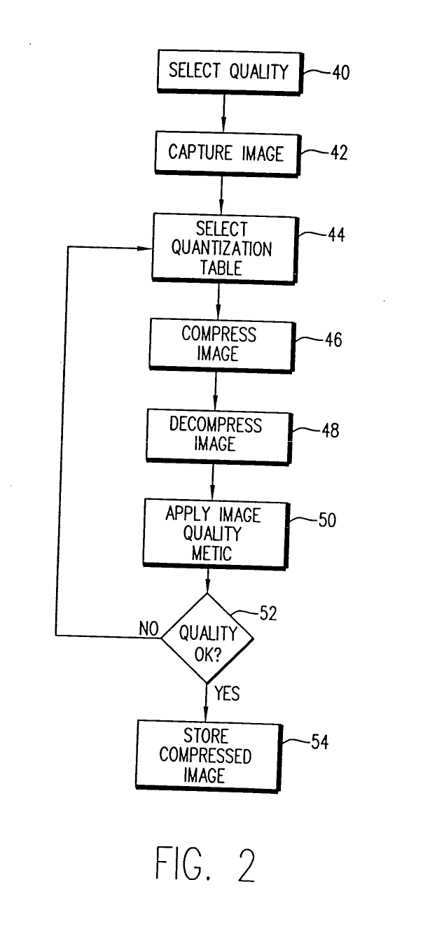

Referred to FIG. 2, which illustrates the flowchart for one embodiment of the current invention. A user selects a quality setting 40, then presses the button to capture an image 42. The digital camera processes the captured sensor image to produce a processed digital image for compression before storing it in the memory card. A copy of the processed digital image is stored in RAM. Based on the quality setting of the user, a default quantization table is selected 44 and is used to compress the digital image 46 to generate a compressed image. Assume the digital camera has three quality setting choices as shown in FIG. 2, three quantization tables (table-best, table-better, and table-good) are pre-selected to be the default tables for the corresponding quality setting choices. In another approach, one quantization table (table-best) is pre-selected as default quantization table for the “Best” quality setting selection, along with two scale factors (scale-better and scale-good). These two scale factors will be used to generate default quantization tables for “Better” and “Good” quality setting selections on the fly by scaling the entries of table-best. These default quantization tables as well as the scaling factors can be pre-determined through studying a large number of consumer type images as well as consumer preferences. A copy of the compressed image is stored in RAM.

The compressed image is then decompressed 48 to reconstruct the processed digital image. Image quality metric(s) is(are) further applied 50 to evaluate the quality of the reconstructed processed digital image. After that, a decision has to be made whether the quality of the reconstructed processed digital image meets the user requirement 52. If the image quality indicated by the image quality metric for the specific reconstructed processed digital image is appropriate for the user selected quality settings, then the copy of the compressed image in RAM is sent to the memory card for storage 54. Otherwise, a more appropriate quantization table is selected, the copy of the processed digital image is then retrieved from RAM and it goes through compression 46, decompression 48, and image quality evaluation 50 steps again, followed with another decision step 52. Recursive loops of step 44, 46, 48, 50 and 52 might be necessary until a satisfying result can be achieved.

For a three-level quality setting of “good”, “better” and “best” with three quantization tables, namely “coarse”, “medium” and “fine”, respectively, the number of recursive loops is limited to 2, incurring additional but reasonable computation. If the initially selected quantization table produces a compressed image with consistent quality to the user selected quality setting, the compressed image is sent to the memory card for storage and no further processing is needed; if the initially selected quantization table produces a compressed image with lower quality than the user selected quality setting, a finer quantization table, if still available, is used to compress the processed digital image, until a satisfying result is achieved; if the initially selected quantization table produces a compressed image with higher quality than the user selected quality setting, a coarser quantization table, if still available, is used to compress the processed digital image, until a satisfying result is achieved. Alternatively, all the available quantization tables can be used to compress the processed digital image, and a satisfying result is selected according to the image quality metric; however this procedure is computationally inefficient compared to the recursive procedure.

Major image quality issues associated with JPEG compression are the severity of blocking and contouring artifacts in a JPEG compressed image. Therefore, any image quality metric that correlates with visual perception of blocking and contouring artifacts may be used in the image quality evaluation step. In the embodiment of the current invention, the metric used is the one described in the commonly assigned U.S. patent application Ser. No. ______ (Docket No. 81593), filed on even date herewith in the names of Q. Yu and J. Luo and entitled “A Method of Detecting the Extent of Blocking and Contouring Artifacts in a Digital Image”, which is incorporated herein by reference. This metric measures both the amount of blocking and contouring artifacts within a JPEG compressed image, and predicts the image quality that will be perceived by consumers. More specifically, this metric is based on a digital image processing method that includes the steps of: forming a column difference image; averaging the values in the columns in the column difference image to produce a column difference array; computing the average of the values in the column difference array that are separated by one block width to produce a block averaged column difference array; locating the peak value in the block averaged column difference array; calculating the mean value of the block averaged column difference array excluding the peak value to produce a column base value; computing the ratio between the peak value and the base value to produce a column ratio; repeating steps the above steps in the row direction to produce a row ratio; and employing the column and row ratios as a measure of the extent of blocking artifacts in the digital image. In an additional series of steps the extent of contouring artifacts is determined by the steps of: locating block boundaries based on the locations of peak values of column and row difference arrays; calculating a DC value for each block; generating a histogram of the block DC values; calculating the Fourier transform of the histogram; locating the first non-DC peak in the Fourier transform domain; calculating a DC quantization step size based on the frequency of the first non-DC peak; and employing the DC quantization step size as a measure of the extent of the contouring artifacts in the digital image.

Note that the entropy encoding process in the compression step and the entropy decoding process in the decompression step cancel each other and they do not affect the image quality of the reconstructed processed digital image. Therefore, for implementation efficiency, these two steps are not included in the embodiment of current invention.

The invention has been described in detail with particular reference to certain preferred embodiments thereof, but it will be understood that variations and modifications can be effected within the spirit and scope of the invention.

### PARTS LIST

10 camera lens
12 image sensor
14 signal processor
16 microprocessor controller
18 RAM
20 memory card
22 LCD
24 push button to increase quality setting
26 push button to select quality setting
28 push button to decrease quality setting
40 quality selection step
42 image capture step
44 quantization table selection step
46 image compression step
48 image decompression step
50 image quality evaluation step
52 image quality checking step
54 image storage step

What is claimed is:

1. A method of storing an image in a digital camera, comprising the steps of:
a) capturing an image;
b) selecting a quantization table based on an image quality metric that is dependent upon the captured image; and
c) compressing the image using the selected quantization table.

2. The method claimed in claim 1, wherein the step b) of selecting a quantization table comprises the steps of:
i) selecting a quality setting;
ii) compressing the image using a quantization table corresponding to the selected quality setting;
iii) decompressing the image;
iv) evaluating the decompressed image with the image quality metric; and
v) adjusting the quantization table such that the quality metric matches the selected quality setting.

3. The method claimed in claim 2, wherein the compressing step ii) is a JPEG compression step involving block DCT, quantization of DCT coefficients, and entropy coding of the quantized coefficients.

4. The method claimed in claim 2, wherein the decompressing step iii) is a JPEG decompression step involving entropy decoding, dequantization of DCT coefficients, and inverse block DCT.

5. The method claimed in claim 3, wherein the step ii) of compressing is performed without entropy coding and the step iii) of decompressing is performed without entropy decoding.

6. The method claimed in claim 4, wherein the step ii) of compressing is performed without entropy coding and the step iii) of decompressing is performed without entropy decoding.
